(19) United States
(12) Patent Application Publication
(10) Pub. No.: US 2025/0362919 A1
(43) Pub. Date: Nov. 27, 2025

(54) METHOD FOR PROCESSING INSTRUCTION, DEVICE, AND STORAGE MEDIUM

(71) Applicants: Xian ESWIN Computing Technology Co., Ltd., Xi'an (CN); Beijing ESWIN Computing Technology Co., Ltd., Beijing (CN)

(72) Inventor: Xiuliang YAN, Beijing (CN)

(21) Appl. No.: 18/952,665

(22) Filed: Nov. 19, 2024

(30) Foreign Application Priority Data
May 24, 2024 (CN) 202410660668.2

(51) Int. Cl. G06F 9/38

(52) U.S. Cl. CPC G06F 9/3806; G06F 9/3861

(57) ABSTRACT

The present application provides a method for processing an instruction, which processes an instruction based on an address stack. The address stack includes a first sub-stack and a second sub-stack, a target address of the first sub-stack is acquired based on a prediction result of an instruction, and a target address of the second sub-stack is acquired based on a committing result of an instruction. The method includes acquiring a prediction result of an operation instruction, wherein the prediction result indicates a predicted next instruction executed after the operation instruction; determining a processing operation for the first sub-stack according to the prediction result; and performing, according to a write pointer of the first sub-stack, the processing operation on the target address corresponding to the prediction result in the first sub-stack, wherein the write pointer of the first sub-stack restricts retreating in a process of performing the processing operation.

### CROSS-REFERENCE TO RELATED APPLICATION

The present application claims priority to Chinese Patent Application No. 202410660668.2, filed on May 24, 2024 and entitled “METHOD FOR PROCESSING INSTRUCTION, APPARATUS, DEVICE, AND STORAGE MEDIUM”, the entire content of which is incorporated herein by reference.

### TECHNICAL FIELD

Embodiments of the present disclosure relate to the field of computer technologies, in particular to a method for processing an instruction, a device, and a storage medium.

### BACKGROUND

In the field of computer technologies, a pipelining technology is used to process a plurality of instructions to be executed. The pipelining technology includes an instruction fetch stage, a decoding stage, and an execution stage. In the case that a first instruction reaches the decoding stage through the instruction fetch stage, a second instruction can be fetched, so as to realize the pipelining execution of the plurality of instructions and improve the processing efficiency of the plurality of instructions.

In the process of processing the instructions by the pipelining technology, it is necessary to predict the next instruction to be processed. Taking a conditional branch instruction as an example of the previously processed instruction, the conditional branch instruction has two branches, and different branches correspond to different next instructions. In this case, the next instruction corresponding to the conditional branch instruction needs to be predicted before the execution of the conditional branch instruction is completed, and the predicted next instruction is valued in advance.

In some cases, after the next instruction is predicted, a target address of the instruction is also determined based on the predicted next instruction, and the target address is counted by a stack, so as to realize the instruction jump based on the counted target address. Therefore, there is an urgent need for a method for processing an instruction to count the target address in the case of predicting the instruction.

### SUMMARY

Embodiments of the present disclosure provide a method for processing an instruction, a device, and a storage medium. The technical solution is as follows.

In one aspect, a method for processing an instruction is provided. The method is configured to process an instruction based on an address stack, wherein the address stack includes a first sub-stack and a second sub-stack, a target address in the first sub-stack is acquired based on a prediction result of an instruction, and a target address in the second sub-stack is acquired based on a committing result of an instruction, and the method includes:
acquiring a prediction result of an operation instruction, wherein the prediction result indicates a next instruction as predicted that is executed after the operation instruction;
determining a processing operation for the first sub-stack according to the prediction result; and

performing, according to a write pointer of the first sub-stack, the processing operation on a target address corresponding to the prediction result in the first sub-stack, wherein the write pointer of the first sub-stack restricts retreating in a process of performing the processing operation, and the write pointer of the first sub-stack is configured to modify an out-of-order portion caused by performing the processing operation in the first sub-stack in the case of determining that the prediction result is an unsuccessful prediction.

In some embodiments, determining the processing operation for the first sub-stack according to the prediction result includes:
determining, in the case that the prediction result indicates that the next instruction is a call instruction, that the processing operation includes a push operation, wherein the push operation is configured to push a target address corresponding to the call instruction into the first sub-stack, and the call instruction is configured to call any program;
or, determining, in the case that the prediction result indicates that the next instruction is a return instruction, that the processing operation includes a pop operation corresponding to the push operation as executed, wherein the pop operation is configured to pop a target address corresponding to the return instruction in the first sub-stack, and the return instruction is configured to return after the end of calling any program.

In some embodiments, performing, according to the write pointer of the first sub-stack, the processing operation on the target address corresponding to the prediction result in the first sub-stack includes:
pushing, in the case that the processing operation includes the push operation, the target address corresponding to the prediction result into the first sub-stack according to the write pointer of the first sub-stack, wherein the write pointer of the first sub-stack advances in the case of pushing the target address;
or, determining, in the case that the processing operation includes the pop operation corresponding to the push operation as executed, the target address corresponding to the prediction result in the target addresses pushed into the first sub-stack according to the write pointer of the first sub-stack, and popping the target address as determined, wherein the write pointer of the first sub-stack remains in an original position in the case of popping the target address.

In some embodiments, determining the target address corresponding to the prediction result in the target addresses pushed into the first sub-stack according to the write pointer of the first sub-stack includes:
determining a historical instruction corresponding to the prediction result, wherein the prediction result indicates an end of calling any program, and the historical instruction is configured to call any program;
determining a write pointer of the historical instruction, wherein the write pointer of the historical instruction is configured to push a target address corresponding to the historical instruction into the first sub-stack; and
acquiring the target address corresponding to the prediction result by searching, according to the write pointer of the historical instruction, the target address corresponding to the historical instruction from at least one target address pushed into the first sub-stack.

In some embodiments, searching, according to the write pointer of the historical instruction, the target address corresponding to the historical instruction from at least one target address pushed into the first sub-stack includes:
acquiring a link relationship between a write pointer and a first stack top pointer of the first sub-stack;
searching a first stack top pointer corresponding to the write pointer of the historical instruction according to the link relationship between the write pointer and the first stack top pointer; and
determining a target address indicated by the first stack top pointer as searched as the target address corresponding to the historical instruction.

In some embodiments, after popping the target address as determined, the method further includes:
retreating the first stack top pointer of the first sub-stack according to a position of the target address as popped.

In some embodiments, after pushing the target address corresponding to the prediction result into the first sub-stack according to the write pointer of the first sub-stack, the method further includes:
establishing the link relationship between the write pointer and the first stack top pointer of the first sub-stack, wherein the link relationship is configured to determine the target address corresponding to the prediction result from the first sub-stack.

In some embodiments, after pushing the target address corresponding to the prediction result into the first sub-stack according to the write pointer of the first sub-stack, the method further includes:
determining a candidate cell in at least one memory cell included in the second sub-stack; and
storing, in the case of committing the prediction result, the target address corresponding to the prediction result in the candidate cell.

In some embodiments, the method further includes:
acquiring an execution result corresponding to the operation instruction, wherein the execution result indicates a next instruction as determined that is executed after the operation instruction; and
determining, in the case that the execution result and the prediction result are different, that the prediction result is an unsuccessful prediction, or determining, in the case that the execution result and the prediction result are the same, that the prediction result is a successful prediction.

In some embodiments, the method further includes:
restoring the write pointer of the first sub-stack according to the out-of-order portion of the first sub-stack; and
correcting the out-of-order portion of the first sub-stack according to the write pointer as restored.

In another aspect, a computer device is provided. The computer device includes a processor and a memory storing at least one computer program, wherein the at least one computer program, when loaded and executed by the processor, causes the computer device to perform the above-mentioned method for processing the instruction.

In still another aspect, a non-transitory computer-readable storage medium is provided. The non-transitory computer-readable storage medium stores at least one computer program, wherein the at least one computer program, when loaded and executed by a processor of a computer, causes the computer to perform the above-mentioned method for processing the instruction.

In still another aspect, a computer program product or a computer program is provided. The computer program product or computer program includes at least one computer instruction stored in a computer-readable storage medium. A processor of a computer device reads the at least one computer instruction from the computer-readable storage medium, and the processor executes the at least one computer instruction to cause the computer device to perform the above-mentioned method for processing the instruction.

### BRIEF DESCRIPTION OF DRAWINGS

FIG. 1 is a schematic diagram of an implementation environment according to some embodiments of the present disclosure;

FIG. 2 is a flowchart of a method for processing an instruction according to some embodiments of the present disclosure;

FIG. 3 is a schematic diagram of a process for processing an instruction according to some embodiments of the present disclosure;

FIG. 4 is a schematic diagram of an address stack according to some embodiments of the present disclosure;

FIG. 5 is a schematic diagram of another address stack according to some embodiments of the present disclosure;

FIG. 6 is a schematic diagram of yet another address stack according to some embodiments of the present disclosure;

FIG. 7 is a schematic structural diagram of an apparatus for processing an instruction according to some embodiments of the present disclosure;

FIG. 8 is a schematic structural diagram of a server according to some embodiments of the present disclosure; and

FIG. 9 is a schematic structural diagram of a device for processing an instruction according to some embodiments of the present disclosure.

### DETAILED DESCRIPTION

To make the objectives, technical solutions, and advantages of the present disclosure clearer, the following further describes the embodiments of the present disclosure in detail with reference to the accompanying drawings.

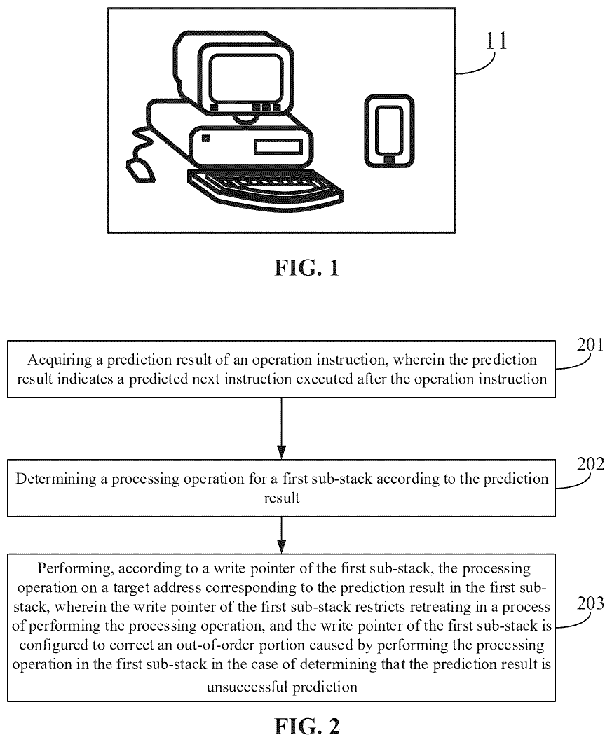

Embodiments of the present disclosure provide a method for processing an instruction, Referring to FIG. 1, which shows a schematic diagram of an implementation environment of the method according to some embodiments of the present disclosure. The implementation environment may include a computing device 11. The computing device 11 installs and runs a processor, and the processor is configured to execute the method for processing the instruction according to the embodiments of the present disclosure, and count a target address according to a prediction result of an operation instruction.

Optionally, the computing device 11 may be a terminal, a server, a switch, a router, or any other device with the processor installed. Exemplarily, the terminal may be any electronic product that can interact with a user in one or more ways such as a keyboard, a touchpad, a touch screen, a remote controller, voice interaction, or a handwriting device, such as a personal computer (PC), a mobile phone, a smart phone, a personal digital assistant (PDA), a wearable device, a pocket PC (PPC), a tablet computer, a smart car machine, a smart television and a smart speaker. The server may be a single server or a server cluster composed of a plurality of servers. The processor installed in the computing device 11 may be a central processing unit (CPU) or other type of processor.

It should be understood by those skilled in the art that the above computing device 11 is only an example, and other existing or future apparatuses, if applicable to the present disclosure, should also be included in the protection scope of the present disclosure and are included here by reference.

The embodiment of the present disclosure provides a method for processing an instruction. The method for processing the instruction may be applied to the above implementation environment shown in FIG. 1, and the method may be executed by the processor included in the computing device 11. A flowchart of the method is shown in FIG. 2 and includes steps 201 to 203.

In step 201, a prediction result of an operation instruction is acquired, wherein the prediction result indicates a predicted next instruction executed after the operation instruction.

Exemplarily, the operation instruction refers to an instruction currently being executed, and the operation instruction may be any type of instruction, including but not limited to a data transfer-like instruction, an operation-like instruction, a program control-like instruction, input and output instructions, etc. In the process of executing the operation instruction, the processor also predicts the next instruction possibly executed after the operation instruction.

For example, after decoding the operation instruction, the type of the operation instruction is determined according to a decoding result, such that the next instruction possibly executed after the operation instruction is predicted according to the type of the operation instruction, and the next instruction is processed in advance. The processing in advance is, for example, to fetch the next instruction from a memory, such that after execution of the operation instruction is completed subsequently, there is no need to fetch the next instruction from the memory, and the next instruction can be directly subjected to an operation after the instruction fetch. The memory is configured to store the instructions to be executed by the processor, the memory and the processor may be configured in the same computer device, and a communication connection is established between the memory and the processor.

In some cases, the type of the operation instruction includes a branch instruction, and the branch instruction is an instruction in a computer program that allows the computer program to jump to different branches of a code according to specific conditions during execution. The branch is configured to realize program run, one branch includes at least one instruction, and after the processor sequentially processes at least one instruction in the branch, the run of the program corresponding to the branch can be realized.

Optionally, in the case that the type of the operation instruction indicates that the operation instruction does not belong to the branch instruction, as the execution of the operation instruction will not lead to a branch jump, the processor may predict that the next instruction is the instruction arranged after the operation instruction in a first branch where the operation instruction is disposed, to acquire the prediction result of the operation instruction.

In some embodiments, in the case that the type of the operation instruction indicates that the operation instruction belongs to the branch instruction, as the execution of the operation instruction will lead to the branch jump, the processor firstly predicts a possibly jumping second branch after executing the branch instruction, and then predicts the next instruction from the second branch, thereby acquiring the prediction result of the operation instruction.

Optionally, the branch instruction may be an unconditional branch instruction, and the unconditional branch instruction is an instruction that the computer program must jump to different branches after execution. The unconditional branch instruction may be a jump instruction, and the jump instruction forces the computer program to jump to a specified code tag or another branch of the program. Optionally, the branch instruction may also be a conditional branch instruction, configured to decide whether to execute the branch according to certain conditions, and the certain conditions may be values in a register or a comparison result. The conditional branch instruction includes but is not limited to beq (branch if equal), bne (branch if not equal), and the like.

The branch instruction may jump to different branches, and taking the conditional branch instruction as an example of the branch instruction, the branch instruction indicates to call an A function when A is less than B, and to call a B function when A is not less than B. Therefore, the next instruction executed after this branch instruction is possibly an instruction in the branch calling the A function or an instruction in the branch calling the B function. Moreover, if the jump is performed according to an execution result of the branch instruction after waiting for complete execution of the branch instruction, the processor cannot process other instructions before execution of the branch instruction, and the efficiency is low. Therefore, the processor can predict a jump condition of the branch instruction before the execution of the branch instruction is completed, predict the second branch executed after the branch instruction, and take the instruction with the highest execution order in the second branch as the next instruction executed after the branch instruction.

The embodiments of the present disclosure do not limit the process of predicting the second branch executed after the branch instruction, but may randomly select a branch from the branches to which the branch instruction possibly jumps as the second branch. Still taking the fact in the above embodiments as an example, that is, the branch instruction indicates to call the A function when A is less than B, and to call the B function when A is not less than B, the two branches corresponding to the branch instruction are A branch of the A function and B branch of the B function, and the processor randomly selects the A branch as the second branch to which the branch instruction possibly jumps.

In one possible case, the second branch executed after the branch instruction may also be a default result set based on experience or the implementation environment. Taking whether the branch instruction indicates to jump to branch C as an example, it is defaulted that the branch instruction will execute the jump, and the branch to which the branch instruction possibly jumps is determined as the branch C. Alternatively, it is defaulted that the branch instruction will not execute the jump, and the second branch executed after the branch instruction is determined as the first branch where the branch instruction is disposed. Optionally, the processor may also acquire a historical jump result, for example, the branch instruction was executed at a historical moment, and determine the branch with the highest execution frequency in the historical jump result as the second branch possibly executed after the branch instruction according to the historical jump result of the branch instruction.

Regardless of the way in which the processor predicts the second branch possibly executed after branch execution, the instruction with the highest execution order on the second branch can be taken as the next instruction executed after the branch instruction, to acquire the prediction result. Taking the possibly executed branch being configured to call the A function as an example, the branch includes at least one instruction executed in the process of calling the A function. The execution order of respective instructions is instruction A, instruction B, and instruction C. The instruction A is an instruction firstly executed in the process of calling the A function, the processor thus determines that the next instruction executed after the branch instruction is the instruction A, and the acquired prediction result indicates that the next instruction executed after the branch instruction is the instruction A.

Optionally, the prediction result may be any information that can indicate the next instruction, including but not limited to an instruction name, an instruction identification, or an instruction fetch address. In the case that the prediction result is an instruction fetch address, acquiring the prediction result of the operation instruction may also be called predicting a target address of the operation instruction.

In step 202, a processing operation for a first sub-stack is determined according to the prediction result.

In one possible case, the next instruction indicated by the prediction result is possibly an indirect jump instruction, and the target address of the indirect jump instruction is read from a register or a memory position and cannot be directly acquired from encoding of the indirect jump instruction. The target address refers to the instruction fetch address of the next instruction executed after execution of the indirect jump instruction, including but not limited to a program counter (PC) value.

Exemplarily, the indirect jump instruction includes a call instruction and a return instruction. The call instruction is configured to call any program and jump the program from a main calling program where the call instruction is disposed to a called program. The return instruction is configured to return after calling any program and return the called program called by the call instruction to the main calling program where the call instruction is disposed. As calling one program includes two steps: calling and returning, the call instruction and the return instruction are processed in pairs, the call instruction is processed firstly, and then the return instruction is processed.

In one possible case, a processing order of the call instruction and the return instruction is a first-in last-out principle, that is, the call instruction is processed firstly, and then the return instruction corresponding to the call instruction is processed. Next, taking program A and program B as examples of the called programs respectively, the paired processing process of the call instruction and the return instruction is explained. The processor firstly processes call instruction 1 to call the program A, and finds, in the process of calling the program A, that a value in the program A needs to be acquired by calculation of the program B. The processor processes call instruction 2 to call the program B, calculates the required value of the program A by executing at least one instruction of the program B, ends the calling of the program B, returns to the program A based on return instruction 2 corresponding to the call instruction 2 and carries the calculated value in the return process. The program A continues to run according to the returned value, and return instruction 1 corresponding to the call instruction 1 is executed after the end of the run of the program A to return the original program where the call instruction 1 is disposed.

Based on the above example, it can be known that the position where the return instruction is returned is the position before the call instruction corresponding to the return instruction jumps, that is, the original branch of the main calling program where the call instruction is disposed. In this case, the adjacent instruction arranged after the call instruction in the original branch is the next instruction to be executed when the main calling program is continuously executed after the return instruction jumps back to the main calling program. Therefore, the adjacent instruction of the call instruction can be counted before the call instruction jumps, such that the counted adjacent instruction of the call instruction is determined as the next instruction to be executed when the return instruction corresponding to the call instruction is executed.

In some cases, processing any instruction needs to fetch the instruction from the memory according to the instruction fetch address of the instruction, and the processor may count the instruction fetch address of the adjacent instruction, that is, the target address, in the process of counting the adjacent instruction, such that the processor can fetch the adjacent instruction directly according to the counted instruction fetch address subsequently. Moreover, as the processing order of the call instruction and the return instruction follows the first-in last-out principle, and the first-in last-out principle is consistent with a data reading and writing principle in an address stack, the target address can be selected to be counted in the address stack.

In some embodiments, the address stack includes a first sub-stack and a second sub-stack, and both the first sub-stack and the second sub-stack are configured to count the target address. The difference is that the target address in the first sub-stack is acquired based on the prediction result of the instruction, that is, after the predicted next instruction is the call instruction or return instruction, the operation will be performed on the first sub-stack, while the target address in the second sub-stack is acquired based on a committing result of the instruction, that is, the operation is performed on the second sub-stack only when the committed next instruction is the call instruction or the return instruction.

FIG. 3 is a schematic structural diagram of an address stack according to some embodiments of the present disclosure. In FIG. 3, return address stack (RAS) indicates the address stack, speculate RAS (Spec RAS) indicates the first sub-stack, and commit RAS indicates the second sub-stack. For the case that the first sub-stack is processed according to the prediction result and the second sub-stack is processed according to the committing result, the processor in the embodiments of the present disclosure processes the first sub-stack according to the prediction result of the operation instruction. For example, as shown in FIG. 3, after the prediction result of the operation instruction is determined by branch prediction, the processing operation may be executed on the Spec RAS according to the prediction result. Optionally, the first sub-stack and the second sub-stack may be set based on experience. For example, the address stack includes 32 memory cells, and the memory cells may also be called table entries in some cases. The first 16 memory cells may serve as the second sub-stack, and the last 16 memory cells may serve as the first sub-stack. The first and last are configured to distinguish a time sequence, and the later the memory cell, the earlier it pops the data.

In one possible case, the processing operation for the first sub-stack includes a push operation or a pop operation, such as push/pop shown in FIG. 3. The processor may determine whether to execute the push operation or pop operation on the first sub-stack according to the prediction result, and a determination process includes but not limited to the following.

Determination process 1: in the case that the prediction result indicates that the next instruction is a call instruction, it is determined that the processing operation includes the push operation.

The push operation is configured to push the target address corresponding to the call instruction into the first sub-stack. The embodiments of the present disclosure do not limit the call instruction possibly executed after the operation instruction. The call instruction may be an instruction for calling the program for the first time, or an instruction for calling the program again after the program has been called. The program that has been called may be a returned program. For example, the next instruction is call instruction A, and call instruction B was executed before the call instruction A for calling function 1. In the process of executing the operation instruction, calculation of the function 1 has been completed, and the processor has executed return instruction B corresponding to the call instruction B for returning. Optionally, the program that has been called may also be an unreturned program. For example, in the above embodiments, the program A is called by the call instruction 1 at first, and then it is predicted that the program B will be called by the call instruction 2 in the process of running the program A.

Regardless of the case of the call instruction, the execution of the call instruction will perform a jump, and the program will jump from the main calling program to the called program. Therefore, the processor will record the target address corresponding to the call instruction to clarify the position of the returned main calling program after the program called by the call instruction finishes running, and the processor will push the target address corresponding to the call instruction into the first sub-stack to record the target address. Optionally, the target address corresponding to the call instruction may be the instruction fetch address of the adjacent instruction of the call instruction.

Determination process 2: in the case that the prediction result indicates that the next instruction is a return instruction, it is determined that the processing operation includes the pop operation, and the pop operation is configured to pop a target address corresponding to the return instruction in the first sub-stack.

In one possible case, the prediction result may also indicate that the next instruction is the return instruction. For example, the processor has ever executed the call instruction, it is predicted that the processor will execute the return instruction corresponding to the call instruction to return the program from the called program to the main calling program, and the main calling program is the program before the call instruction jumps. The processor may pop the target address corresponding to the return instruction from the first sub-stack, so as to clarify the position where the return instruction is to be returned. Subsequently, the processor may fetch the adjacent instruction from the memory based on the target address, and execute the adjacent instruction after the prediction result, thereby returning the program from the called program to the main calling program. Optionally, the target address corresponding to the return instruction may be the instruction fetch address of the adjacent instruction of the call instruction corresponding to the return instruction.

In step 203, according to a write pointer of the first sub-stack, the processing operation is performed on the target address corresponding to the prediction result in the first sub-stack, wherein the write pointer of the first sub-stack restricts retreating in the process of performing the processing operation, and the write pointer of the first sub-stack is configured to correct an out-of-order portion caused by performing the processing operation in the first sub-stack in the case of determining that the prediction result is an unsuccessful prediction.

Exemplarily, the pointer is configured to indicate a certain memory cell in the stack, and the write pointer of the first sub-stack is configured to indicate the memory cell in the first sub-stack for pushing the target address. After determining the processing operation for the first sub-stack, the processor may determine the memory cell corresponding to the target address according to the write pointer, and perform the processing operation on the determined memory cell. For example, the target address is pushed into the determined memory cell, or the target address in the determined memory cell is popped.

For the processing operation which may be a push operation or a pop operation in step 202, next, the processes of performing different processing operations in the first sub-stack according to the write pointer are introduced respectively.

Process 1: in the case that the processing operation includes the push operation, the target address corresponding to the prediction result is pushed into the first sub-stack according to the write pointer of the first sub-stack, and the write pointer of the first sub-stack advances in the case of pushing the target address.

Exemplarily, the processor determines the memory cell indicated by the write pointer of the first sub-stack, and pushes the target address corresponding to the call instruction into the memory cell indicated by the write pointer. As the memory cell indicated by the write pointer has been occupied by the target address after the target address is pushed to the write pointer, the processor will also update the write pointer and control the write pointer to point to one new unoccupied memory cell. For example, the processor adds 1 to a value of the write pointer, thereby updating the memory cell indicated by the write pointer to be above a push position of the target address.

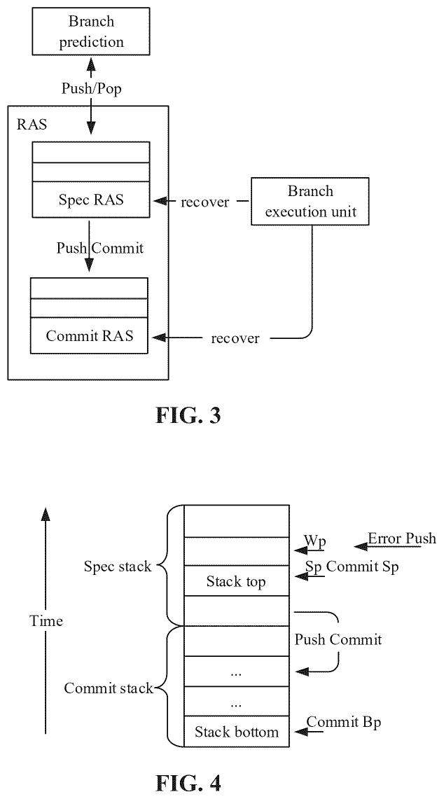

FIG. 4 is an address stack according to some embodiments of the present disclosure, Spec stack indicates the first sub-stack, Commit stack indicates the second sub-stack, and the time arrow on the left indicates that the newly pushed target address is disposed above. Wp indicates the write pointer and Sp indicates a first stack top pointer. In FIG. 4, the original stack top of the Spec stack is disposed in the fourth row of memory cells. After the target address is pushed into the third row of memory cells, the write pointer advances by one, and points to the second row of memory cells.

In some embodiments, the address stack belongs to a linear table, only one end is subjected to push and pop, and the end subjected to the push and pop may be called the stack top. Therefore, after the processor pushes the target address corresponding to the call instruction into the first sub-stack, the pushed target address becomes the new stack top of the first sub-stack. In some cases, the processor may update the first stack top pointer for indicating the stack top after pushing the target address. The updating process is, for example, to add 1 to a value of the first stack top pointer. Optionally, the write pointer of the first sub-stack will also advance. Continuously taking FIG. 4 as an example, in FIG. 4, after the target address is pushed into the third row of memory cells, the new stack top is updated to the third row of memory cells.

In one possible case, after the processor pushes the target address into the first sub-stack, a link relationship between the write pointer and the first stack top pointer of the first sub-stack will also be established. The position of the target address written based on the write pointer in the first sub-stack is described through the link relationship between the write pointer and the first stack top pointer, such that the target address corresponding to the prediction result is searched according to the link relationship in the case that the target address corresponding to the prediction result is to be determined from the first sub-stack subsequently. The detailed process of searching the target address according to the link relationship may refer to the relevant content of executing the pop operation in Process 2 below, which will not be repeated here.

Optionally, after pushing the target address into the first sub-stack based on the prediction result, the processor will also determine a candidate cell in at least one memory cell included in the second sub-stack, the candidate cell is indicated based on a second stack top pointer of the second sub-stack, and the second stack top pointer may be called commit sp in some cases. By determining the candidate cell, the target address corresponding to the prediction result pre-allocation in the second sub-stack is written into the position, and subsequently, the target address corresponding to the prediction result is stored in the candidate cell in the case of committing the prediction result.

In one possible case, as the first sub-stack and the second sub-stack are disposed in the same address stack, and one address stack includes one stack entry and one stack exit, for the target address to be pushed into the second sub-stack, the processor adopts an internal target address transfer method to move the target address of the first sub-stack into the candidate cell, for example, as shown in FIG. 3, the target address pushed into the Spec RAS is committed to the commit RAS. Taking FIG. 4 as an example again, the push commit arrow in FIG. 4 reflects a moving track of the target address, and the head and tail of the push commit arrow respectively point to the candidate cell in the second sub-stack and a storage cell with the target address corresponding to the prediction result in the first sub-stack. By moving the target address in the first sub-stack into the second sub-stack, the memory cells in the first sub-stack are further released on the basis of counting the target address according to the committing result.

Optionally, the target address pushed into the candidate cell of the second sub-stack may also be the target address not pushed into the address stack. For example, according to a write pointer of the second sub-stack, the target address is pushed into the candidate cell of the second sub-stack, and the process of pushing the target address into the second sub-stack is similar to the process of pushing the address into the first sub-stack, which will not be repeated here.

Process 2: in the case that the processing operation includes the pop operation corresponding to the executed push operation, the target address corresponding to the prediction result is determined in the target addresses pushed into the first sub-stack according to the write pointer of the first sub-stack, the determined target address is popped, and the write pointer of the first sub-stack remains in the original position in the case of popping the target address.

Optionally, for the case that the prediction result is a return instruction indicating the end of calling any program and the processing operation is the pop operation, the processor will firstly determine the target address corresponding to the prediction result from the target addresses in the first sub-stack, and the determination process includes, for example, determining a historical instruction corresponding to the prediction result, the historical instruction being configured to call any program; determining a write pointer of the historical instruction, the write pointer being configured to push a target address corresponding to the historical instruction into the first sub-stack; and acquiring the target address corresponding to the prediction result by searching, according to the writing pointer of the historical instruction, the target address corresponding to the historical instruction from at least one target address pushed into the first sub-stack.

In one possible case, the target address corresponding to the return instruction and the target address corresponding to the call instruction are the same, and are both the instruction fetch address of the adjacent instruction arranged after the call instruction in the original branch where the call instruction is disposed. In this case, the processor may firstly determine the call instruction corresponding to the return instruction, the call instruction being a historical instruction predicted before the return instruction. Optionally, in the case that the return instruction indicates the end of calling any program, the return instruction is possibly disposed at the end of a code of any program. In this case, the processor may determine any program corresponding to the return instruction according to a code position of the return instruction, search the call instruction for calling any program, and acquire the historical instruction corresponding to the return instruction.

After determining the historical instruction corresponding to the return instruction, the processor may search the target address pushed into the first sub-stack in the process of executing the historical instruction for the program jump in the first sub-stack. The processor also executes based on the write pointer of the first sub-stack in the process of pushing the target address corresponding to the historical instruction. Therefore, after determining the write pointer corresponding to the historical instruction, the processor can search the target address corresponding to the historical instruction from the first sub-stack according to the write pointer.

For the case in Process 1, the processor will also establish the link relationship between the write pointer and the first stack top pointer after pushing the target address, as the historical instruction belongs to the call instruction, the processor will also push the target address according to the write pointer and establish the link relationship between the write pointer and the first stack top pointer in the case of predicting the historical instruction with the process being the same as Process 1. In this case, the processor may search the target address in combination with the link relationship.

Exemplarily, the search process includes: acquiring the link relationship between the write pointer and the first stack top pointer of the first sub-stack; searching, according to the link relationship between the write pointer and the first stack top pointer, a first stack top pointer corresponding to the write pointer of the historical instruction; and determining the target address indicated by the searched first stack top pointer as the target address corresponding to the historical instruction.

Optionally, the processor may access the storage cell to acquire the stored link relationship, and the storage cell may be a storage cell inside the processor or a storage cell provided by other modules establishing a communication connection with the processor. After accessing a storage space to acquire the link relationship between the write pointer and the first stack top pointer, the processor retrieves the write pointer of the historical instruction in the link relationship, and determines the first stack top pointer establishing the link relationship with the hit write pointer as the first stack top pointer corresponding to the write pointer of the historical instruction after hitting the write pointer. An index used by the processor to retrieve the write pointer may be any identification information capable of distinguishing the write pointer at different moments, including but not limited to a push moment of the write pointer, a name or serial number of the write pointer, etc.

Referring to the introduction in Process 1, the first stack top pointer points to the new stack top of the first sub-stack after the target address is pushed, and the new stack top is the position of the target address corresponding to the historical instruction in the first sub-stack. Therefore, the processor can determine a historical unit indicated by the first stack top pointer corresponding to the historical instruction, and determine the target address stored in the historical unit as the target address corresponding to the historical instruction.

In one possible case, there may be no target address in the historical unit, that is, the historical unit is an empty unit. If the historical instruction corresponding to the return instruction is a predicted and committed call instruction, the description of Process 1 is referred. In the process of committing the call instruction, the target address corresponding to the call instruction will also move from the first sub-stack to the second sub-stack. In this case, the target address originally stored in the history unit has moved to the second sub-stack, and the history unit is empty. Based on the fact that there is no target address in the history unit, the processor may determine that the history instruction has been committed and searched as the candidate cell determined by the history instruction in the second sub-stack, and the target address in the candidate cell is determined as the target address corresponding to the history instruction.

After determining the target address corresponding to the historical instruction, the processor may pop the determined target address. In one possible case, if the target address to be popped is disposed in the second sub-stack, the processor will pop the target address corresponding to the prediction result from the second sub-stack. As the second sub-stack is a sub-stack maintained according to an actual committing result, both the write pointer and the second stack top pointer of the second sub-stack will be retreated in the pop process. In this case, popping the target address from the second sub-stack includes reading and deleting the target address, Deletion of the target address is based on the retreating of the write pointer of the second sub-stack. For example, after the target address is popped up, the write pointer in the second sub-stack is retreated. In this case, the target address pushed into the second sub-stack subsequently will overwrite the previously popped target address according to the retreated write pointer of the second sub-stack, to achieve the effect of deleting the popped target address.

Exemplarily, if the target address to be popped is disposed in the first sub-stack, the processor may read the target address corresponding to the prediction result from the first sub-stack, and keep the target address in the first sub-stack. Referring to the description in Process 1, after the predicted call instruction is committed, the processor will move the target address of the first sub-stack to the second sub-stack, and write the target address through internal transfer of the address stack. Based on this, the processor will keep the target address of the first sub-stack.

In one possible case, keeping the target address in the first sub-stack may be achieved by restricting the retreating of the write pointer of the first sub-stack, such as remaining the write pointer in the original position. Continuously taking FIG. 4 as an example, in FIG. 4, the target address corresponding to the prediction result is the target address stored in the memory cell marked as the stack top. After reading the target address from the memory cell, the processor remains the write pointer at the position above the stack top, that is, the second row of memory cells. Subsequently, the target address of the first sub-stack will be pushed, and the memory cells at the stack top for pushing, that is, the second row of memory cells, will not overwrite the target address kept in the third row of memory cells, so as to avoid deletion of the target address.

In some embodiments, as the processor points to the pop operation in the case of predicting the return instruction, even if the processor does not delete the target address, the stack top of the first sub-stack will still be updated. The process of adjusting the first stack top pointer of the first sub-stack by the processor includes but is not limited to retreating the first stack top pointer of the first sub-stack according to the position of the popped target address.

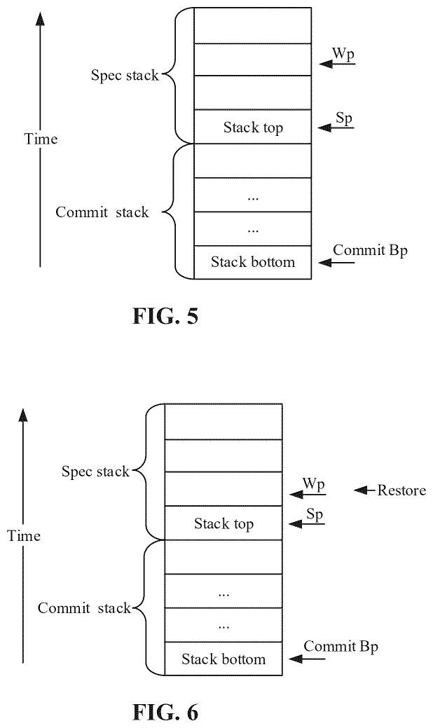

In the case that the target address is disposed in the history unit, the first stack top pointer may be retreated to the memory unit below a history stack. For example, the first stack top pointer is retreated to the next unit of the history unit where the popped target address is disposed. FIG. 5 is a schematic structural diagram of another address stack according to some embodiments of the present disclosure. The structure of the address stack of FIG. 5 is similar to the structure of the address stack of FIG. 4, and the detailed description may refer to the introduction on the address stack of FIG. 4, and will not be repeated here. In FIG. 5, after the target address in the third row of memory cells is popped, the first stack top pointer is retreated to the fourth row of memory cells, and in FIG. 5, the write pointer of the first sub-stack remains in the second row of memory cells without retreating.

The write pointer will not be retreated in the case of popping the target address, that is, the new target address pushed again after popping the target address will not overwrite the target address of the first sub-stack, thereby ensuring the information integrity of the first sub-stack. The reason for ensuring the information integrity is that if the predicted call instruction has a prediction error, the target address pushed into the first sub-stack based on the prediction error will not overwrite the real target address to be popped. The real target address to be popped refers to the target address to be pushed into the second sub-stack and popped in the second sub-stack. If the predicted return instruction has a prediction error, the executed pop operation is a pop operation that should not be executed. As the processor keeps the target address in the first sub-stack in the popping process, the erroneously executed pop operation will not lead to a reduction of the target address of the first sub-stack, so as to avoid the deletion of the target address that should be stored.

In one possible case, the processor will also verify whether the prediction result is a successful prediction after performing the processing operation on the first sub-stack. The prediction process includes but is not limited to acquiring the execution result corresponding to the operation instruction, the execution result indicating the determined next instruction executed after the operation instruction; and in the case that the execution result and the prediction result are different, determining that the prediction result is an unsuccessful prediction, or in the case that the execution result and the prediction result are the same, determining that the prediction result is a successful prediction.

Optionally, after completing the execution of the operation instruction, the processor may determine the next instruction to be executed according to the execution result of the operation instruction and start execution. For example, in step 201, in the case that the operation instruction is a branch instruction, the processor determines that A is not less than B according to the execution result, and determines that the function to be called is the B function and the next instruction to be executed is the call instruction corresponding to the B function.

After acquiring the execution result, the processor may compare the prediction result with the execution result, and if the prediction result is consistent with the execution result, it is indicated that the prediction is successful. For example, the predicted next instruction is also the call instruction corresponding to the B function, and the prediction result is a successful prediction. In this case, as the processor has processed the next instruction in advance according to the prediction result, for example, the instruction is fetched in advance, the processor may directly decode the fetched next instruction.

In one possible case, if the prediction result is inconsistent with the execution result, it is indicated that the prediction result is an unsuccessful prediction. For example, the predicted next instruction is the call instruction corresponding to the A function, while the actually executed next instruction is the call instruction corresponding to the B function, and the prediction result is an unsuccessful prediction.

In the case that the prediction result is an unsuccessful prediction, the processing operation performed based on the prediction result is an erroneous processing operation that should not be performed, and the processor will correct an out-of-order portion caused by the processing operation in the first sub-stack. The instruction continuously predicted based on the prediction result of a prediction failure is also erroneous, and the portion of the target address that is pushed or popped after the prediction result in the first sub-stack is also erroneous. Therefore, the out-of-order portion of the first sub-stack includes the target address that is pushed or popped based on the processing operation and the target address that is pushed or popped after performing the processing operation. Optionally, the out-of-order portion of the first sub-stack is indicated based on the first stack top pointer corresponding to the prediction result. The first stack top pointer corresponding to the prediction result refers to the first stack top pointer updated after processing the first sub-stack based on the prediction result. If the prediction result is a call instruction, the first stack top pointer corresponding to the prediction result is the first stack top pointer advancing after pushing the target address; and if the prediction result is a return instruction, the first stack top pointer corresponding to the prediction result is the retreated first stack top pointer. The out-of-order portion indicated by a first stack bottom pointer is the memory cells disposed between the stack top of the first sub-stack and the first stack top pointer corresponding to the prediction result.

Exemplarily, the process of correcting the out-of-order portion of the first sub-stack by the processor includes: restoring the write pointer of the first sub-stack according to the out-of-order portion of the first sub-stack; and correcting the out-of-order portion of the first sub-stack according to the restored write pointer. The processor determines the first stack top pointer corresponding to the write pointer corresponding to the prediction result according to the link relationship between the write pointer and the first stack top pointer, and restores the write pointer of the first sub-stack according to the determined first stack top pointer. If the prediction result is a call instruction, the out-of-order portion includes the target address based on error push of the call instruction, and the processor may restore the write pointer of the first sub-stack to the position before pushing the target address corresponding to the call instruction. The position before pushing the target address corresponding to the call instruction is determined according to the first stack top pointer corresponding to the write pointer. FIG. 6 shows the recovered first sub-stack. The recovered error is the erroneously predicted call instruction, and the error push shown in FIG. 4 is executed. The write pointer after the error push points to the second row, and the processor restores the write pointer of the first sub-stack to the third row, and points to the target address of the error push. Subsequently, the target address pushed based on the write pointer will overwrite the target address of the error push, which realizes correction of the out-of-order portion. In one possible case, the processor will correct the first stack top pointer of the first sub-stack in addition to the write pointer.

In some embodiments, if the prediction result is a return instruction, the out-of-order portion includes the target address based on error pop of the return instruction. As the processor retreats the first stack top pointer in the process of popping the target address in the first sub-stack, the write pointer remains in the original position to save the target address in the first sub-stack, Therefore, there is no lack of target address in the first sub-stack, and the processor can restore the write pointer of the first sub-stack to be above the target address of the error pop. Subsequently, the target address may be pushed into the first sub-stack again based on the restored write pointer in the process of predicting the instruction, which realizes the correction of the out-of-order portion of the first sub-stack. In one possible case, the processor will also correct the first stack top pointer.

In the process of correcting the first sub-stack, the processor does not need to adjust the target address stored in the first sub-stack, but only needs to restore the write pointer and the first stack top pointer in the first sub-stack, such that the out-of-order portion can be corrected, and the correction process is simple and efficient. Moreover, the target address in the second sub-stack is not referred in the process of correcting the first sub-stack, and the first sub-stack can be corrected without a need to wait for the next instruction indicated by the execution result to be committed, that is, the target address of the next instruction is pushed or popped in the second sub-stack. Even if the processor follows the principles of sequential emission, out-of-order execution, and sequential committing in the process of processing the instruction, for the prediction result of prediction failure found in the execution state, the out-of-order correction can be realized in the execution stage through recorded wp and sp of the first sub-stack and commit sp and commit bp of the second sub-stack without a need to wait for the committing stage, and the correction has high timeliness. The commit bp indicates a stack bottom pointer of the second sub-stack.

Optionally, the processor may correct the out-of-order portion of the first sub-stack by a branch execution unit as shown in FIG. 3. In FIG. 3, the branch execution unit can not only recover the first sub-stack, but also recover the second sub-stack. For example, in the above embodiments, if the target address corresponding to the return instruction with a prediction error is in the second sub-stack, and the operation of popping the return instruction in the second sub-stack is an erroneous operation, there will also be an out-of-order portion to be recovered in the second sub-stack. The branch execution unit may recover the second sub-stack according to the committing result and the previously executed call instruction and return instruction.

In summary, in the method for processing the instruction according to the embodiments of the present disclosure, the first sub-stack and the second sub-stack are disposed in the same address stack, the processor only needs to maintain one stack structure, and the hardware overhead is low. By restricting the retreating of the write pointer of the first sub-stack, the deletion of the target address in the first sub-stack is avoided, and address integrity of the first sub-stack is ensured. In the case that the prediction result is an unsuccessful prediction, the first sub-stack can be corrected by restoring the write pointer, with correction process being simple and the correction efficiency being high. In addition, the target address stored in the second sub-stack is not referred in the process of correcting the first sub-stack. Therefore, the correction can be performed by completing the corresponding operation in the second sub-stack without a need to wait for the oldest instruction to be committed, which realizes advanced out-of-order correction of the first sub-stack and improves working efficiency of the first sub-stack.

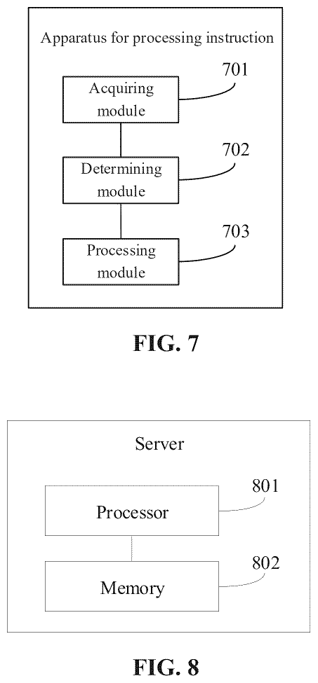

Referring to FIG. 7, some embodiments of the present disclosure provide an apparatus for processing an instruction, the apparatus is configured to process an instruction based on an address stack, wherein the address stack includes a first sub-stack and a second sub-stack, a target address in the first sub-stack is acquired based on a prediction result of an instruction, a target address in the second sub-stack is acquired based on a committing result of an instruction, and the apparatus includes:
an acquiring module 701, configured to acquire a prediction result of an operation instruction, wherein the prediction result indicates a next instruction as predicted that is executed after the operation instruction;
a determining module 702, configured to determine a processing operation for the first sub-stack according to the prediction result; and
a processing module 703, configured to perform, according to a write pointer of the first sub-stack, the processing operation on the target address corresponding to the prediction result in the first sub-stack, wherein the write pointer of the first sub-stack restricts retreating in a process of executing the processing operation, and the write pointer of the first sub-stack is configured to correct an out-of-order portion caused by performing the processing operation in the first sub-stack in the case of determining that the prediction result is an unsuccessful prediction.

In some embodiments, the determining module 702 is configured to determine, in the case that the prediction result indicates that the next instruction is a call instruction, that the processing operation includes a push operation, wherein the push operation is configured to push a target address corresponding to the call instruction into the first sub-stack, and the call instruction is configured to call any program; or, determine, in the case that the prediction result indicates that the next instruction is a return instruction, that the processing operation includes a pop operation corresponding to the executed push operation, wherein the pop operation is configured to pop a target address corresponding to the return instruction in the first sub-stack, and the return instruction is configured to return after the end of calling any program.

In some embodiments, the processing module 703 is configured to push, in the case that the processing operation includes the push operation, the target address corresponding to the prediction result into the first sub-stack according to the write pointer of the first sub-stack, wherein the write pointer of the first sub-stack advances in the case of pushing the target address; or, determine, in the case that the processing operation includes the pop operation corresponding to the executed push operation, the target address corresponding to the prediction result in the target addresses pushed into the first sub-stack according to the write pointer of the first sub-stack, and pop the determined target address, wherein the write pointer of the first sub-stack remains in an original position in the case of popping the target address.

In some embodiments, the processing module 703 is configured to determine a historical instruction corresponding to the prediction result, wherein the prediction result indicates the end of calling any program call, and the historical instruction is configured to call any program; determine a write pointer of the historical instruction, wherein the write pointer of the historical instruction is configured to push a target address corresponding to the historical instruction into the first sub-stack; and acquire the target address corresponding to the prediction result by searching, according to the write pointer of the historical instruction, the target address corresponding to the historical instruction from at least one target address pushed into the first sub-stack.

In some embodiments, the processing module 703 is configured to acquire a link relationship between a write pointer and a first stack top pointer of the first sub-stack; search a first stack top pointer corresponding to the write pointer of the historical instruction according to the link relationship between the write pointer and the first stack top pointer; and determine a target address indicated by the searched first stack top pointer as the target address corresponding to the historical instruction.

In some embodiments, the processing module 703 is further configured to retreat the first stack top pointer of the first sub-stack according to a position of the popped target address.

In some embodiments, the processing module 703 is further configured to establish the link relationship between the write pointer and the first stack top pointer of the first sub-stack, wherein the link relationship is configured to determine the target address corresponding to the prediction result from the first sub-stack.

In some embodiments, the processing module 703 is further configured to determine a candidate cell in at least one memory cell included in the second sub-stack; and store, in the case of committing the prediction result, the target address corresponding to the prediction result in the candidate cell.

In some embodiments, the acquiring module 701 is further configured to acquire an execution result corresponding to the operation instruction, wherein the execution result indicates a determined next instruction executed after the operation instruction; and the determining module 702 is further configured to determine, in the case that the execution result and the prediction result are different, that the prediction result is an unsuccessful prediction, or determine, in the case that the execution result and the prediction result are the same, that the prediction result is a successful prediction.

In some embodiments, the apparatus further includes a correcting module configured to restore the write pointer of the first sub-stack according to the out-of-order portion of the first sub-stack; and correct the out-of-order portion of the first sub-stack according to the restored write pointer.

The first sub-stack and the second sub-stack are disposed in the same address stack, the apparatus only needs to maintain one stack structure, and the hardware overhead is low. As the write pointer is configured to push the target address into the first sub-stack, the retreating of the write pointer of the first sub-stack is restricted, and it is ensured that the newly pushed target address will not overwrite the original target address in the first sub-stack, thus ensuring address integrity of the first sub-stack.

It should be noted that the apparatus according to the above embodiments only takes division of all the above functional modules as an example for explanation when realizing its functions. In practice, the above functions may be finished by the different functional modules as required. That is, the internal structure of the apparatus is divided into different functional modules to finish all or part of the functions described above. In addition, the apparatus according to the above embodiments has the same concept as the method embodiments, the specific implementation process of which can refer to the method embodiments and will not be repeated here.

FIG. 8 is a schematic structural diagram showing a server according to some embodiments of the present disclosure. For example, the server may vary significantly in configuration or capabilities, and may include one or more processors 801 (for example, one or more central processing units (CPUs)), and one or more memories 802. The one or more memories 802 store at least one instruction which may be loaded and executed by the processor 801 to realize the method for processing the instructions provided by the above embodiments. In some embodiments, the server may also include a wired or wireless interface, a keyboard, an input/output interface, and the like to facilitate input/output, and other components for realizing functions of the device, which will not be described in detail herein.

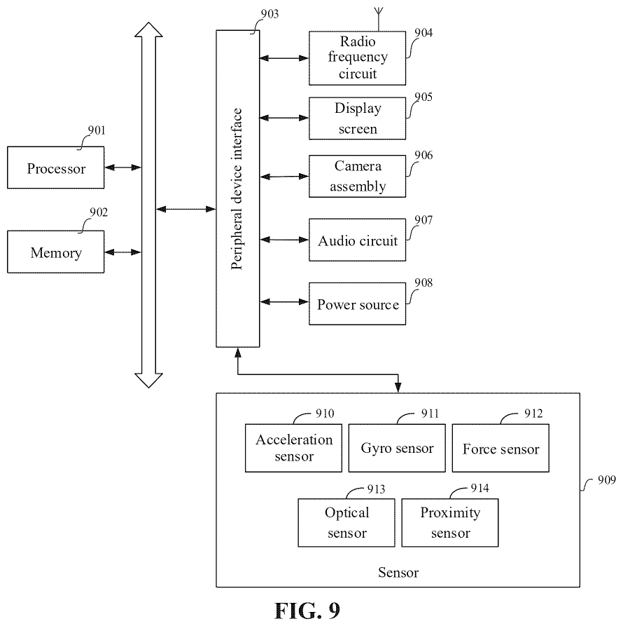

FIG. 9 shows a schematic structural diagram of a device for processing an instruction provided by some embodiments of the present disclosure. The device may be a terminal, such as a smart mobile phone, a tablet computer, a player, a notebook computer, or a desktop computer. The terminal may also be referred to as user equipment, a portable terminal, a laptop terminal, a desktop terminal, or the like.

Usually, the terminal includes a processor 901 and a memory 902.

The processor 901 may include one or more processing cores, such as a 4-core processor and an 8-core processor. The processor 901 may be formed by at least one hardware of a digital signal processing (DSP), a field-programmable gate array (FPGA), and a programmable logic array (PLA). The processor 901 may also include a main processor and a coprocessor. The main processor is a processor for processing the data in an awake state, and is also called a central processing unit (CPU). The coprocessor is a low-power-consumption processor for processing the data in a standby state. In some embodiments, the processor 901 may be integrated with a graphics processing unit (GPU), which is configured to render and draw the content that needs to be displayed by a display screen. In some embodiments, the processor 901 may also include an artificial intelligence (AI) processor configured to process computational operations related to machine learning.

The memory 902 may include one or more computer-readable storage mediums, which can be non-transitory. The memory 902 may also include a high-speed random access memory, as well as a non-volatile memory, such as one or more disk storage devices and flash storage devices. In some embodiments, the non-transitory computer-readable storage medium in the memory 902 is configured to store at least one instruction. The at least one instruction is configured to be executed by the processor 901 to perform the method for processing the instruction according to the method embodiments of the present disclosure.

In some embodiments, the terminal also optionally includes a peripheral device interface 903 and at least one peripheral device. The processor 901, the memory 902, and the peripheral device interface 903 may be connected by a bus or a signal line. Each peripheral device may be connected to the peripheral device interface 903 by a bus, a signal line, or a circuit board. Specifically, the peripheral device includes at least one of a radio frequency circuit 904, a display screen 905, a camera assembly 906, an audio circuit 907, and a power source 908.

The peripheral device interface 903 may be configured to connect at least one peripheral device associated with an input/output (I/O) to the processor 901 and the memory 902. In some embodiments, the processor 901, the memory 902, and the peripheral device interface 903 are integrated on the same chip or circuit board. In some other embodiments, any one or two of the processor 901, the memory 902, and the peripheral device interface 903 may be implemented on a separate chip or circuit board, which is not limited in the present disclosure.

The radio frequency circuit 904 is configured to receive and transmit a radio frequency (RF) signal, which is also referred to as an electromagnetic signal. The radio frequency circuit 904 communicates with a communication network and other communication devices via the electromagnetic signal. The radio frequency circuit 904 converts the electrical signal into the electromagnetic signal for transmission, or converts the received electromagnetic signal into the electrical signal. Optionally, the radio frequency circuit 904 includes an antenna system, an RF transceiver, one or more amplifiers, a tuner, an oscillator, a digital signal processor, a codec chipset, a subscriber identity module card, and the like. The radio frequency circuit 904 can communicate with other terminals via at least one wireless communication protocol. The wireless communication protocol includes, but is not limited to, the World Wide Web, a metropolitan area network, an intranet, various generations of mobile communication networks (2G, 3G, 4G, and 5G), a wireless local area network, and/or a wireless fidelity (Wi-Fi) network. In some embodiments, the RF circuit 904 may also include near-field communication (NFC) related circuits, which is not limited in the present disclosure.

The display screen 905 is configured to display a user interface (UI). The UI may include graphics, text, icons, videos, and any combination thereof. When the display screen 905 is a touch display screen, the display screen 905 also has the capacity to acquire touch signals on or over the surface of the display screen 905. The touch signal may be input into the processor 901 as a control signal for processing. At this time, the display screen 905 may also be configured to provide virtual buttons and/or virtual keyboards, which are also referred to as soft buttons and/or soft keyboards. In some embodiments, one display screen 905 may be disposed on the front panel of the terminal. In some other embodiments, at least two display screens 505 may be disposed respectively on different surfaces of the terminal or in a folded design. In further embodiments, the display screen 905 may be a flexible display screen disposed on the curved or folded surface of the terminal. Even the display screen 905 may have an irregular shape other than a rectangle; that is, the display screen 905 may be an irregular-shaped screen. The display screen 905 may be an organic light-emitting diode (OLED) display screen.

The camera assembly 906 is configured to capture images or videos. Optionally, the camera assembly 906 includes a front camera and a rear camera. Usually, the front camera is placed on the front panel of the terminal, and the rear camera is placed on the back of the terminal. In some embodiments, at least two rear cameras are disposed, and are at least one of a main camera, a depth-of-field camera, a wide-angle camera, and a telephoto camera respectively, so as to realize a background blurring function achieved by fusion of the main camera and the depth-of-field camera, panoramic shooting and virtual reality (VR) shooting functions achieved by fusion of the main camera and the wide-angle camera or other fusion shooting functions. In some embodiments, the camera assembly 906 may also include a flashlight. The flashlight may be a mono-color temperature flashlight or a two-color temperature flashlight. The two-color temperature flash is a combination of a warm flashlight and a cold flashlight and can be used for light compensation at different color temperatures.

The audio circuit 907 may include a microphone and a speaker. The microphone is configured to collect sound waves of users and environments, and convert the sound waves into electrical signals which are input into the processor 901 for processing, or input into the RF circuit 904 for voice communication. For stereo acquisition or noise reduction, there may be a plurality of microphones respectively disposed at different locations of the terminal. The microphone may also be an array microphone or an omnidirectional acquisition microphone. The speaker is then configured to convert the electrical signals from the processor 901 or the radio frequency circuit 904 into the sound waves. The speaker may be a conventional film speaker or a piezoelectric ceramic speaker. When the speaker is a piezoelectric ceramic speaker, the electrical signal can be converted into not only human-audible sound waves but also the sound waves which are inaudible to humans to range and the like. In some embodiments, the audio circuit 907 may also include a headphone jack.

The power source 908 is configured to power up various components in the terminal. The power source 908 may supply alternating current or direct current, or maybe a disposable battery, or a rechargeable battery. When the power source 908 includes the rechargeable battery, the rechargeable battery may be a wired rechargeable battery or a wireless rechargeable battery. The rechargeable battery may also support the fast charging technology.

In some embodiments, the terminal also includes one or more sensors 909. The one or more sensors 909 include, but are not limited to, an acceleration sensor 910, a gyro sensor 911, a force sensor 912, an optical sensor 913, and a proximity sensor 914.

The acceleration sensor 910 may detect magnitudes of accelerations on three coordinate axes of a coordinate system established by the terminal. For example, the acceleration sensor 910 may be configured to detect components of a gravitational acceleration on the three coordinate axes. The processor 901 may control the display screen 905 to display a user interface in a landscape view or a portrait view according to a gravity acceleration signal collected by the acceleration sensor 910. The acceleration sensor 910 may also be configured to collect motion data of a game or a user.

The gyro sensor 911 can detect a body direction and a rotation angle of the terminal, and can cooperate with the acceleration sensor 910 to collect a 3D motion of the user on the terminal. Based on the data collected by the gyro sensor 911, the processor 901 can serve the following functions: motion sensing (such as changing the UI according to a user's tilt operation), image stabilization during shooting, game control, and inertial navigation.

The force sensor 912 may be disposed on a side frame of the terminal and/or a lower layer of the display screen 905. When the force sensor 912 is disposed on the side frame of the terminal, a user's holding signal to the terminal can be detected. The processor 901 can perform left-right hand recognition or quick operation according to the holding signal collected by the force sensor 912. When the force sensor 912 is disposed on the lower layer of the display screen 905, the processor 901 controls an operable control on the UI according to a user's pressure operation on the display screen 905. The operable control includes at least one of a button control, a scroll bar control, an icon control and a menu control.

The optical sensor 913 is configured to collect ambient light intensity. In some embodiments, the processor 901 may control the display brightness of the display screen 905 according to the ambient light intensity collected by the optical sensor 913. Specifically, when the ambient light intensity is high, the display brightness of the display screen 905 is increased; and when the ambient light intensity is low, the display brightness of the display screen 905 is decreased. In other embodiments, the processor 901 may also dynamically adjust shooting parameters of the camera assembly 906 according to the ambient light intensity collected by the optical sensor 913.

The proximity sensor 914, also referred to as a distance sensor, is usually disposed on the front panel of the terminal. The proximity sensor 914 is configured to capture a distance between the user and a front surface of the terminal. In one embodiment, when the proximity sensor 914 detects that the distance between the user and the front surface of the terminal becomes gradually smaller, the processor 901 controls the display screen 905 to switch from a screen-on state to a screen-off state. When it is detected that the distance between the user and the front surface of the terminal gradually increases, the processor 901 controls the display screen 905 to switch from the screen-off state to the screen-on state.

It will be understood by those skilled in the art that the structure shown in FIG. 9 does not constitute a limitation on the device for processing the instruction, and may include more or fewer components than those illustrated, or combine some components, or adopt different component arrangements.

In some embodiments, a computer device is provided. The computer device includes a processor and a memory storing at least one computer program. The at least one computer program, when loaded and executed by the processor, causes the computer device to perform the method for processing the instruction as described above.

In some embodiments, a non-transitory computer-readable storage medium is also provided. The non-transitory computer-readable storage medium stores at least one computer program. The at least one computer program, when loaded and executed by at least one processor of a computer device, causes the computer device to perform the method for processing the instruction as described above.

In a possible implementation, the above computer-readable storage medium may be a read-only memory (ROM), a random access memory (RAM), a portable compact disk read-only memory (CD-ROM), a magnetic tape, a floppy disk, an optical storage device, or the like.

In some embodiments, a computer program product or a computer program is also provided. The computer program product or the computer program includes at least one computer instruction. The at least one computer instruction is stored in a computer-readable storage medium. A processor of a computer device can read the at least one computer instruction from the computer-readable storage medium, and execute the same, such that the computer device can perform the method for processing the instruction as described above.

It should be noted that the information (including, but not limited to, users' equipment information, users' personal information, etc.), data (including, but not limited to, data used for analysis, data stored, data displayed, etc.), and signals involved in the present disclosure are authorized by the user or are fully authorized by the parties, and the collection, use, and processing of the relevant data are required to comply with relevant laws, regulations, and standards of the relevant countries and regions. For example, the prediction results involved in this disclosure are obtained with full authorization.

It should be understood that “a plurality of” referred to herein means two or more. The term “and/or”, describing an association relationship of the associated objects, indicates that three kinds of relationships may exist, e.g., A and/or B, which may be represented as A alone, both A and B, and B alone. The character “/” generally indicates that the associated objects are in an “or” relationship.

The foregoing is only exemplary embodiments of the present disclosure, and is not intended to limit the disclosure. Any modifications, equivalent substitutions, improvements, etc. made within the principles of the present disclosure shall be included in the scope of protection of the present disclosure.

1. A method for processing an instruction, being applied to process an instruction based on an address stack, wherein the address stack comprises a first sub-stack and a second sub-stack, a target address in the first sub-stack is acquired based on a prediction result of an instruction, and a target address in the second sub-stack is acquired based on a committing result of an instruction, the method comprises:
acquiring a prediction result of an operation instruction, wherein the prediction result indicates a next instruction as predicted that is executed after the operation instruction;
determining a processing operation for the first sub-stack according to the prediction result; and
performing, according to a write pointer of the first sub-stack, the processing operation on a target address corresponding to the prediction result in the first sub-stack, wherein the write pointer of the first sub-stack restricts retreating in a process of performing the processing operation, and the write pointer of the first sub-stack is configured to correct an out-of-order portion caused by performing the processing operation in the first sub-stack in a case of determining that the prediction result is an unsuccessful prediction.

2. The method according to claim 1, wherein said determining the processing operation for the first sub-stack according to the prediction result comprises:
determining, in a case that the prediction result indicates that the next instruction is a call instruction, that the processing operation comprises a push operation, wherein the push operation is configured to push a target address corresponding to the call instruction into the first sub-stack, and the call instruction is configured to call any program;
or, determining, in a case that the prediction result indicates that the next instruction is a return instruction, that the processing operation comprises a pop operation corresponding to the push operation as executed, wherein the pop operation is configured to pop a target address corresponding to the return instruction in the first sub-stack, and the return instruction is configured to return after an end of calling any program.

3. The method according to claim 1, wherein said performing, according to the write pointer of the first sub-stack, the processing operation on the target address corresponding to the prediction result in the first sub-stack comprises:
pushing, in a case that the processing operation comprises a push operation, the target address corresponding to the prediction result into the first sub-stack according to the write pointer of the first sub-stack, wherein the write pointer of the first sub-stack advances in a case of pushing the target address;
or, determining, in a case that the processing operation comprises a pop operation corresponding to the push operation as executed, the target address corresponding to the prediction result in the target addresses pushed into the first sub-stack according to the write pointer of the first sub-stack, and popping the target address as determined, wherein the write pointer of the first sub-stack remains in an original position in a case of popping the target address.

4. The method according to claim 3, wherein said determining the target address corresponding to the prediction result in the target addresses pushed into the first sub-stack according to the write pointer of the first sub-stack comprises:
determining a historical instruction corresponding to the prediction result, wherein the prediction result indicates an end of calling any program, and the historical instruction is configured to call any program;
determining a write pointer of the historical instruction, wherein the write pointer of the historical instruction is configured to push a target address corresponding to the historical instruction into the first sub-stack; and
acquiring the target address corresponding to the prediction result by searching, according to the write pointer of the historical instruction, the target address corresponding to the historical instruction from at least one target address pushed into the first sub-stack.

5. The method according to claim 4, wherein said searching, according to the write pointer of the historical instruction, the target address corresponding to the historical instruction from at least one target address pushed into the first sub-stack comprises:
acquiring a link relationship between a write pointer and a first stack top pointer of the first searching a first stack top pointer corresponding to the write pointer of the historical instruction according to the link relationship between the write pointer and the first stack top pointer; and
determining a target address indicated by the first stack top pointer as searched as the target address corresponding to the historical instruction.

6. The method according to claim 3, after popping the target address as determined, further comprising:
retreating a first stack top pointer of the first sub-stack according to a position of the target address as popped.

7. The method according to claim 4, after popping the target address as determined, further comprising:
retreating a first stack top pointer of the first sub-stack according to a position of the target address as popped.

8. The method according to claim 5, after popping the target address as determined, further comprising:
retreating the first stack top pointer of the first sub-stack according to a position of the target address as popped.

9. The method according to claim 3, after pushing the target address corresponding to the prediction result into the first sub-stack according to the write pointer of the first sub-stack, further comprising:
establishing a link relationship between a write pointer and a first stack top pointer of the first sub-stack, wherein the link relationship is configured to determine the target address corresponding to the prediction result from the first sub-stack.

10. The method according to claim 4, after pushing the target address corresponding to the prediction result into the first sub-stack according to the write pointer of the first sub-stack, further comprising:
establishing a link relationship between a write pointer and a first stack top pointer of the first sub-stack, wherein the link relationship is configured to determine the target address corresponding to the prediction result from the first sub-stack.

11. The method according to claim 5, after pushing the target address corresponding to the prediction result into the first sub-stack according to the write pointer of the first sub-stack, further comprising:
establishing the link relationship between the write pointer and the first stack top pointer of the first sub-stack, wherein the link relationship is configured to determine the target address corresponding to the prediction result from the first sub-stack.

12. The method according to claim 3, after pushing the target address corresponding to the prediction result into the first sub-stack according to the write pointer of the first sub-stack, further comprising:
determining a candidate cell in at least one memory cell included in the second sub-stack; and
storing, in a case of committing the prediction result, the target address corresponding to the prediction result in the candidate cell.

13. The method according to claim 4, after pushing the target address corresponding to the prediction result into the first sub-stack according to the write pointer of the first sub-stack, further comprising:
determining a candidate cell in at least one memory cell included in the second sub-stack; and
storing, in a case of committing the prediction result, the target address corresponding to the prediction result in the candidate cell.

14. The method according to claim 5, after pushing the target address corresponding to the prediction result into the first sub-stack according to the write pointer of the first sub-stack, further comprising:
determining a candidate cell in at least one memory cell included in the second sub-stack; and
storing, in a case of committing the prediction result, the target address corresponding to the prediction result in the candidate cell.

15. The method according to claim 1, further comprising:
acquiring an execution result corresponding to the operation instruction, wherein the execution result indicates a next instruction as determined that is executed after the operation instruction; and
determining, in a case that the execution result and the prediction result are different, that the prediction result is an unsuccessful prediction, or determining, in a case that the execution result and the prediction result are a same, that the prediction result is a successful prediction.

16. The method according to claim 2, further comprising:
acquiring an execution result corresponding to the operation instruction, wherein the execution result indicates a determined next instruction executed after the operation instruction; and
determining, in a case that the execution result and the prediction result are different, that the prediction result is an unsuccessful prediction, or determining, in a case that the execution result and the prediction result are a same, that the prediction result is a successful prediction.

17. The method according to claim 1, further comprising:
restoring the write pointer of the first sub-stack according to the out-of-order portion of the first sub-stack; and
correcting the out-of-order portion of the first sub-stack according to the write pointer as restored.

18. A computer device, comprising a processor and a memory storing at least one computer program, wherein the at least one computer program, when loaded and executed by the processor, causes the computer device to perform the method for processing the instruction as defined in claim 1.

19. A non-transitory computer-readable storage medium storing at least one computer program, wherein the at least one computer program, when loaded and executed by a processor of a computer, causes the computer to perform the method for processing the instruction as defined in claim 1.

20. A computer program product, comprising at least one computer program or at least one instruction, wherein the at least one computer program or at least one instruction, when executed by a processor of a computer, causes the computer to perform the method for processing the instruction as defined in claim 1.
